(19) United States
(12) Patent Application Publication
(10) Pub. No.: US 2025/0145065 A1
(43) Pub. Date: May 8, 2025

(54) VEHICLE SEATING ASSEMBLY

(71) Applicant: Ford Global Technologies, LLC, Dearborn, MI (US)

(72) Inventors: Sandeep Khengare, Irvine, CA (US); Arya Sabeti, Dearborn, MI (US); Swati Pol, Tamil Nadu (IN); Anand Arumugam, Tamil Nadu (IN); Krishnan Haridoss, Tamil Nadu (IN); Parameswararao Pothuraju, Canton, MI (US)

(73) Assignee: Ford Global Technologies, LLC, Dearborn, MI (US)

(21) Appl. No.: 18/503,358

(22) Filed: Nov. 7, 2023

(51) Int. Cl. B60N 2/30

(52) U.S. Cl. CPC B60N 2/3011; B60N 2/3065

(57) ABSTRACT

A vehicle seating assembly includes a seat base, a seat back pivotably coupled with the seat base, a seat portion pivotably coupled with the seat back. The seat portion pivotably coupled with the seat base. The vehicle seating assembly further includes an articulation mechanism coupled to the seat back to pivot the seat back between an upright position and a folded position. The seat portion translates in response to the seat back pivoting.

### FIELD OF THE DISCLOSURE

The present disclosure generally relates to a vehicle seating assembly, and more specifically relates to a folding seating assembly.

### BACKGROUND OF THE DISCLOSURE

Motor vehicles are commonly equipped with vehicle seating assemblies typically having a seat base and seat back. Some seating assemblies may fold the seat back onto the seat base. It would be desirable to provide for a vehicle seating assembly that folds lower to a vehicle floor.

### SUMMARY OF THE DISCLOSURE

According to a first aspect of the present disclosure, a vehicle seating assembly comprises a vehicle seating assembly that includes a seat base, a seat back pivotably coupled with the seat base, a seat portion pivotably coupled with the seat back. The seat portion pivotably coupled with the seat base. The vehicle seating assembly further includes an articulation mechanism coupled to the seat back to pivot the seat back between an upright position and a folded position. The seat portion translates in response to the seat back pivoting.

Embodiments of the first aspect of the present disclosure can include any one or a combination of the following features:
the seat portion includes a first end coupled with the seat back; and a second end opposite the first end, the second end coupled with the seat base;
the seat base includes: a track coupled with a vehicle floor, the track having a back end and a front end opposite the back end; a support member coupled with the track at the back end, the support member pivotably coupled with the seat back, the support member extending between the support member and the seat back; and a leg pivotably coupled with the front end of the track, the leg pivotably coupled with the seat portion, the leg extending between the front end of the track and the seat portion;
the seat portion, the track, and the vehicle floor remain substantially parallel as the seat back pivots;
the seat portion includes an L-shaped lateral member;
the seat portion translates forward in response to the seat back pivoting toward the folded position;
the seat portion translates downward in response to the seat back pivoting toward the folded position;
the seat back has a first contour, and wherein the seat portion has a second contour complementary of the first contour when the seat back is in the folded position; and
the seat back pivots relative to the seat portion about a first axis, wherein the seat back pivots relative to the seat base about a second axis, and wherein the first axis rotates about the second axis.

According to a second aspect of the present disclosure, a vehicle seating assembly comprises a vehicle includes a seating assembly. The seating assembly includes a seat base. The seat base includes a track having a back end and a front end. The seat base includes a leg pivotably coupled with the front end of the track. The seat base further includes a support member coupled with the back end of the track. The seating assembly further includes a seat back pivotably coupled with the support member. The seating assembly further includes a seat portion having a first end and a second end. The first end pivotably coupled with the seat back. The second end pivotably coupled with the leg. The seating assembly further includes an articulation mechanism coupled to the seat back to pivot the seat back between an upright position and a folded position. The leg rotates about the front end of the track in response to the seat back pivoting. The seat portion translates between a disposed, forward position and a seating position in response to the seat back pivoting.

Embodiments of the second aspect of the present disclosure can include any one or a combination of the following features:
the seat back pivots relative to the first end of the seat portion about a first axis, wherein the seat back pivots relative to the seat base about a second axis, and wherein the first axis rotates about the second axis;
the seat portion translates forward and downward in response to the seat back pivoting toward the folded position;
an angle between the track and the seat portion remains constant as the seat portion translates.
the angle is about zero degrees;
the articulation mechanism includes a motor;
the seat portion includes: a platform assembly; an L-shaped lateral member coupled with the platform assembly at the second end of the seat portion; and a seat cross member coupled with L-shaped lateral member between the first end and the second end, the platform assembly coupled with the seat cross member.
the platform assembly slopes between the second end and the first end; and
the second end of the seat portion orbits the front end of the track.

According to a third aspect of the present disclosure, a vehicle seating assembly comprises a seating assembly for a vehicle, the seating assembly includes a seat base. The seat base includes a pair of tracks having a back end and a front end. The pair of tracks are coupled by a track cross member extending therebetween. The seat base further includes a pair of legs pivotably coupled with the front end of the pair of tracks, respectively. The seat base further includes a pair of support members statically coupled with the back end of the pair of tracks, respectively. The pair of support members are coupled by a support cross member extending therebetween. The vehicle seating assembly further includes a seat back pivotably coupled with the pair of support members. The seat back pivots between an upright position and a folded position. The vehicle seating assembly further includes a seat portion. The seat portion includes a pair of L-shaped lateral members having a first arm and a second arm. The first arm is pivotably coupled with the seat back. The second arm is pivotably coupled with the leg. The seat portion further includes a seat cross member coupled with the pair of L-shaped lateral members at the second arm. The seat cross member extending between the pair of L-shaped lateral members. The seat portion further includes a platform assembly coupled with the second arm of the pair of L-shaped lateral members and the seat cross member. The platform assembly extends therebetween. The vehicle seating assembly further includes an articulation mechanism coupled to the seat back to pivot the seat back between an upright position and a folded position. The pair of legs rotate about the front end of the pair of tracks in response to the seat back pivoting. The seat portion translates between a disposed, forward position and a seating position in response to the seat back pivoting.

Embodiments of the third aspect of the present disclosure can include any one or a combination of the following features:
the first arm of the pair of L-shaped lateral members orbits a first axis in response to the seat back pivoting, the first axis extending through the first arm and the seat back, wherein the second arm of the pair of L-shaped lateral members orbits a third axis in response to the seat back pivoting, the third axis extending through the front end of the pair of tracks and the pair of legs, and wherein the seat portion remains substantially parallel to the pair of tracks.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of the an interior cabin of a vehicle;

FIG. 2 is a upper front perspective view of a seating assembly;

FIG. 3 is a side elevation view of the seating assembly in an upright position;

FIG. 4 is a side elevation view of the seating assembly between the upright position and a folded position;

FIG. 5 is a side elevation view of the seating assembly in the folded position; and

FIG. 6 is a side elevation view of the seating assembly in the folded position.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

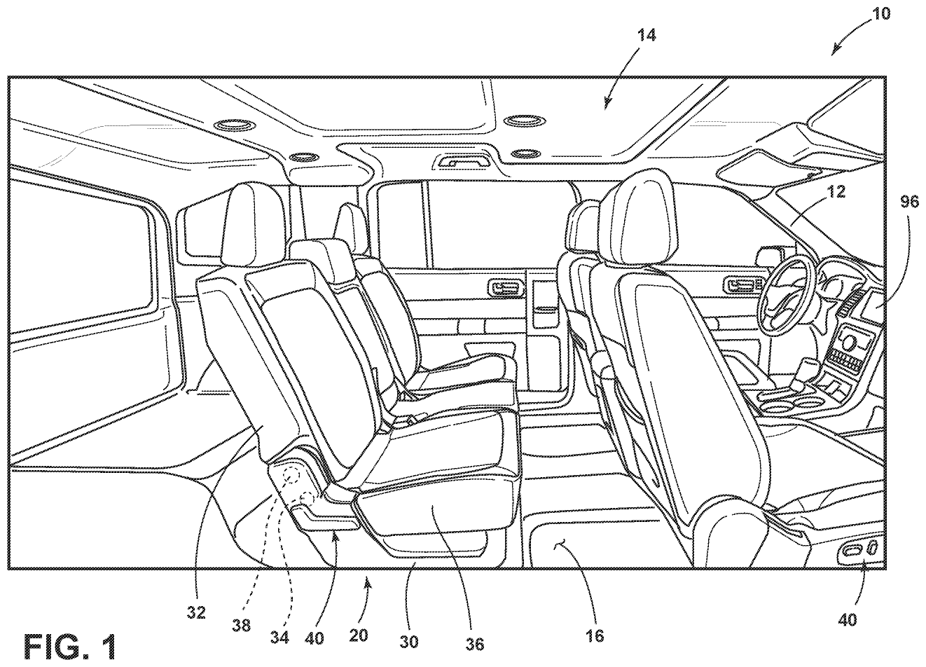

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a seating assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a wheeled automotive or motor vehicle 10 is generally illustrated configured with passenger seating for transporting one or more passengers including a driver and passengers of the motor vehicle 10 and for further transporting one or more items onboard the motor vehicle 10. The motor vehicle 10 has a vehicle body 12 that generally defines a cabin interior 14. The cabin interior 14 may contain various features and trim components. The cabin interior 14 is shown having an arrangement of seats including a seating assembly 20 configured to seat a driver or a passenger, for example. The motor vehicle 10 may also include a human-machine interface (HMI) 96. The motor vehicle 10 illustrated in one example also has additional seating such as a second row of seating that may include a series of the seating assembly 20. The motor vehicle 10 may include additional seating as is common for a large van or bus. It should be appreciated that the motor vehicle 10 may be a motor vehicle, such as a wheeled car, truck, SUV, van or bus, for example, or an airplane, train, boat or other vehicle capable of transporting one or more passengers and items.

With further reference to FIG. 1, the seating assembly 20 includes a seat base 30 coupled with a floor 16 of the cabin interior 14 of the motor vehicle 10. The seat base 30 is pivotably connected to a seat back 32 via a first pivot mechanism 34 (e.g., a gear assembly, a prismatic rod, or similar mechanism). The seat back 32 is pivotably connected to a seat portion 36 via a second pivot mechanism 38 (e.g., a gear assembly, a prismatic rod, or similar mechanism). The seating assembly 20 includes an actuator 40 coupled with the seat base 30. The actuator 40 may, for example, be electrical or mechanical, as shown between the seating assembly 20 in the front and the rear of the cabin interior 14, respectively.

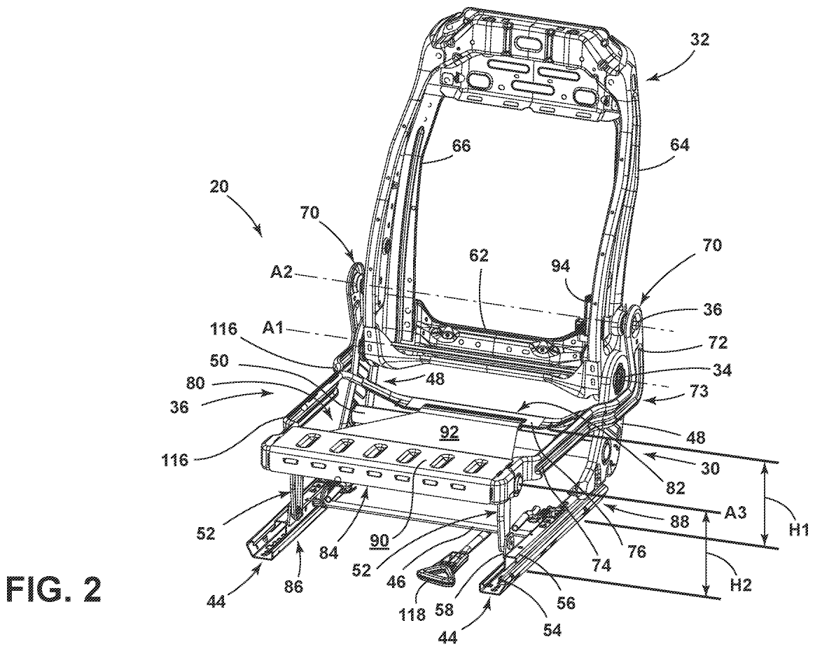

With reference to FIG. 2, the seat base 30 includes a track 44, the track 44 mounted on the floor 16 of the cabin interior 14. The seating assembly 20 illustrated in FIG. 2 may be in the first row, the second row, or the Nth row, for example. The track 44 includes a front end 86 and a back end 88 opposite the front end 86. The track 44 is coupled with a support member 48 proximal the back end 88. The track 44 is pivotably coupled with a leg 52 proximal the front end 86. The seat base 30 may include a pair of tracks 44 that include the track 44. The seat base 30 may include a pair of support members 48 that include the support member 48. The seat base 30 may include a pair of legs 52 that include the leg 52. The pair of tracks 44 may be coupled together via a track cross member 46 extending between the pair of tracks 44. The pair of support members 48 may be coupled together via a support cross member 50, in the form of a towel bar, extending between the pair of support members 48. The track 44 may include an outer track 54 and an inner track 56 disposed within the outer track 54. The support member 48 may be specifically coupled with the inner track 56. More specifically, the support member 48 may be statically coupled with the inner track 56 via, for example, fasteners, welds, or other similar coupling mechanisms. The leg 52 may be specifically pivotably coupled with the inner track 56. The inner track 56 may include a protrusion 58. The leg 52 may be pivotably coupled with the protrusion 58 of the inner track 56 via, for example, a fastener. The track cross member 46 may include a translation actuator 118. Actuation of the translation actuator 118 (FIG. 1) may allow the seating assembly 20 to translate by sliding the inner track 56 within the outer track 54. The inner track 56 may translate forward and backward, for example.

With further reference to FIG. 2, the support member 48 is pivotably coupled with the seat back 32 via the first pivot mechanism 34. The first pivot mechanism 34 is axially aligned with a first axis, A1. Thus, the seat back 32 pivots about the first axis A1. The seat back 32 extends radially from the first axis A1. The support member 48 extends radially from the first axis A1. The seat back 32 includes a bottom member 62 axially aligned with the first axis A1. The seat back 32 includes a first lateral member 64 coupled with the bottom member 62. The seat back 32 includes a second lateral member 66 coupled with the bottom member 62. The first lateral member 64 and the second lateral member 66 radially extend from the first axis A1. The first lateral member 64 and the second lateral member 66 may be coupled with the bottom member 62 via welds, fasteners, or other similar coupling mechanisms. The seat back 32 may laterally extend between the pair of support members 48 such that the first lateral member 64 and the second lateral member 66 are between the pair of support members 48. Additionally, or alternatively, the pair of support members 48 may be between the first lateral member 64 and the second lateral member 66.

With further reference to FIG. 2, the seating assembly 20 includes an articulation mechanism 94 in communication with the actuator 40. The articulation mechanism 94 is coupled with the first pivot mechanism 34. The articulation mechanism 94 pivots the seat back 32 about the first pivot mechanism 34. The articulation mechanism 94 may be disposed within the seat back 32. Additionally, or alternatively, the articulation mechanism 94 may be disposed elsewhere in the motor vehicle 10 or more specifically, in the seating assembly 20 (e.g., the seat back 32 or the seat portion 36). The HMI 96 (FIG. 1) may be in communication with the articulation mechanism 94, such that a user at the HMI 96 can command the articulation mechanism 94 to pivot the seat back 32 to incline or recline the seat back.

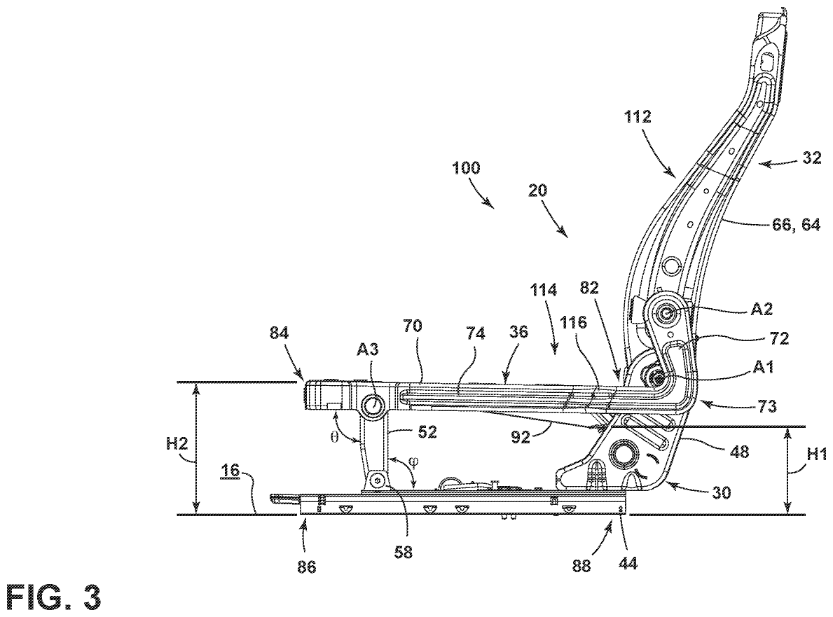

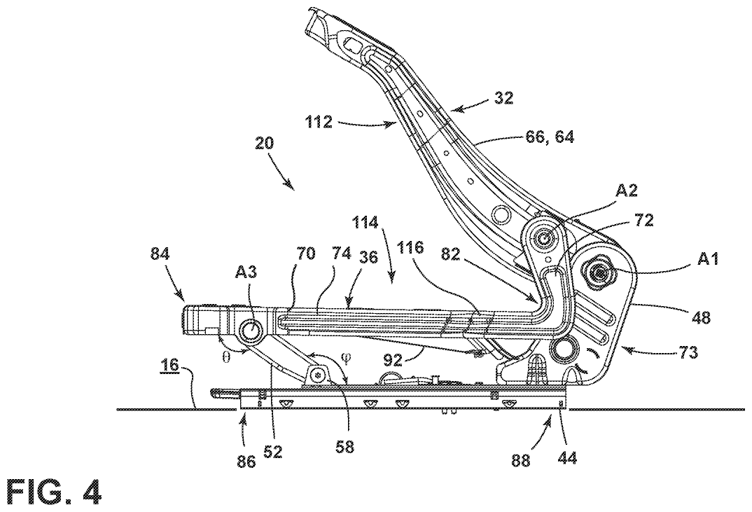

With further reference to FIG. 2, the seat portion 36 has a first end 82 proximal the support member 48 and a second end 84 distal the support member 48 and proximal the leg 52. The seat portion 36 includes an L-shaped lateral member 70A. The L-shaped lateral member 70A is pivotably coupled with the seat back 32 via the second pivot mechanism 38. The second pivot mechanism 38 is axially aligned with a second axis, A2. Thus, the seat portion 36 pivots about the second axis A2 relative to the seat back 32. The L-shaped lateral member 70A includes a first arm 72 pivotably coupled with the seat back 32 and a second arm 74 coupled with the first arm 72. The first arm 72 is generally vertical such that the seat back 32 pivots relative to the firm 72 while the first arm 72 remains generally vertical. The second arm 74 is generally horizontal such that the second arm 74 remains generally horizontal as the seat back 32 pivots. The second arm 74 extends forward from the first arm 72. The L-shaped lateral member 70A has a profile 73 (also illustrated in FIGS. 3-5). The profile 73 of the L-shaped lateral member 70A at the first arm 72 may taper such that a width of the first arm 72 decreases along a direction of radially extent from the second axis A2 (further illustrated in FIGS. 3-5). The seat portion 36 may include a pair of L-shaped lateral members 70 that include the L-shaped lateral member 70A. The first lateral member 64 and the second lateral member 66 of the seat back 32 may be between the pair of L-shaped lateral members 70 of the seat portion 36 at the first arm 72. Additionally, or alternatively, the pair of L-shaped lateral members 70 of the seat portion 36 at the first arm 72 may be between first lateral member 64 and the second lateral member 66 of the seat back 32 (not shown).

With further reference to FIG. 2, the second arm 74 of the L-shaped lateral member 70A may include at least one bend 116 such that a distance between the pair of L-shaped lateral members 70 varies along a length of the second arm 74. For example, the distance between the pair of L-shaped lateral member 70A may decrease as the second arm 74 extends away from the first arm 72. The seat portion 36 may include a seat cross member 76 coupled with and extending between the pair of L-shaped lateral members 70. The seat cross member 76 may be coupled with the second arm 74, for example.

With further reference to FIG. 2, the seat portion 36 includes a platform assembly 80. The platform assembly 80 includes a seat pan 90 and a trampoline 92. The seat pan 90 is coupled with the second arm 74 of the pair of L-shaped lateral members 70, the seat pan 90 extending therebetween. The trampoline 92 is coupled with the seat pan 90 and the seat cross member 76, the trampoline 92 extends between the seat pan 90 and the seat cross member 76. The trampoline 92 may taper in width from the seat pan 90 toward the seat cross member 76. The seat cross member 76 may extend between the pair of L-shaped lateral members 70 at a first height, H1. The seat pan 90 may extend between the pair of L-shaped lateral members 70 at a second height, H2. H1 may be less than H2 such that the trampoline 92 slopes from the seat pan 90 toward the seat cross member 76. Therefore, the seat portion 36 may also slope from the second end 84 toward the first end 82.

With even further reference to FIG. 2, the leg 52 is pivotably coupled with the seat portion 36, such that the leg 52 pivots about a third axis A3. More specifically, the leg 52 may be pivotably coupled with the second arm 74 of the L-shaped lateral member 70A proximal the second end 84 of the seat portion 36. The pair of legs 52 may be between the pair of L-shaped lateral members 70. Additionally, or alternatively, the pair of L-shaped lateral members 70 may be between the pair of legs 52 (not shown).

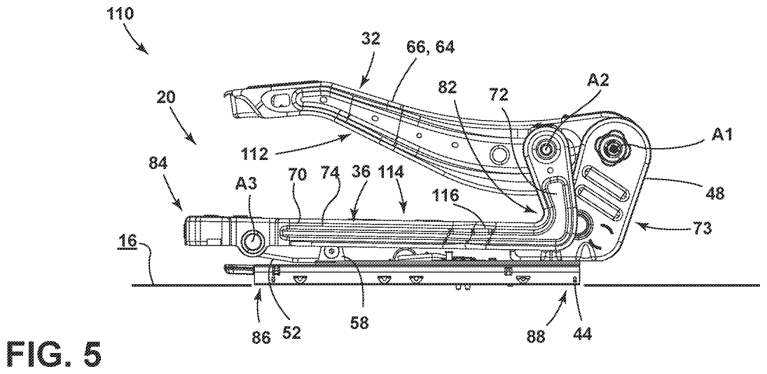

With reference to FIGS. 3-5, the seat back 32 pivots between an upright position 100 configured to seat an occupant (FIG. 3) and a folded position 110 (FIG. 5) which is a stowed configuration. The seat back 32 has a first contour 112 where the first lateral member 64 and the second lateral member 66 extend backward from the bottom member 62 in the upright position 100. The seat portion 36 that slopes from the second end 84 toward the first end 82 has a second contour 114. The first axis A1 is below the second axis A2 in the upright position 100. A first angle θ between the leg 52 and the track 44 is equal to a second angle φ between the leg 52 and the L-shaped lateral member 70A at the second arm 74. In other words, the first angle θ and the second angle φ are congruent and corresponding. The first angle θ and the second angle φ may be about 90 degrees when the seat back 32 is in the upright position 100. Additionally, or alternatively, the first angle θ and the second angle φ may range from about 90 degrees in the upright position 100 to about 0 degrees in the folded position 110. Further, if the seat back 32 were to recline, the first angle θ and the second angle φ may range between about 90 degrees to about 180 degrees.

With further reference to FIGS. 3-5 the profile 73 of the L-shaped lateral member 70A may, for example, resemble that of a hockey stick or field hockey such that the first arm 72 is acutely angled from the second arm 74. For example, the first arm 72 may be angled about 80 degrees or less relative to the second arm 74. Therefore, the first pivot mechanism 34 may be between the first arm 72 and the second arm 74 when the seat back 32 is in the upright position 100.

With further reference to FIGS. 3-5, as the articulation mechanism 94 pivots the seat back 32, the second axis A2 orbits the first axis A1. Further, as the articulation mechanism 94 pivots the seat back 32, the seat portion 36 is translated. More specifically, the seat portion 36 is translated forward as the seat back 32 is pivoted from the upright position 100 toward the folded position 110 and translated rearward as the seat back 32 is pivoted from the folded position 110 toward the upright position 100. Further, the seat portion 36 is translated downward as the seat back 32 is pivoted from the upright position 100 toward the folded position 110 and translated upward as the seat back 32 is pivoted from the folded position 110 toward the upright position 100. Therefore, the seat portion 36 translates between a seating position, when the seat back 32 is in the upright position 100, and a disposed, forward position, when the seat back 32 is in the folded position 110. Even further, the first angle θ and the second angle φ decrease as the seat back 32 is pivoted from the upright position 100 toward the folded position 110 and increase as the seat back 32 is pivoted from the folded position 110 toward the upright position 100.

With even further reference to FIGS. 3-5, the second axis A2 is forward of the first axis A1 when the seat back 32 is in the folded position 110. The first angle θ and the second angle φ are smaller when the seat back 32 is in the folded position 110 than when the seat back 32 is in the upright position 100. The first angle θ and the second angle φ may be about 0 degrees when the seat back 32 is in the folded position 110. The seat portion 36 may remain substantially parallel to the track 44 as the seat back 32 is pivoted between the upright position 100 and the folded position 110. Additionally, or alternatively, the seat portion 36 may remain substantially parallel with the floor 16 of the motor vehicle 10 as the seat back 32 is pivoted between the upright position 100 and the folded position 110.

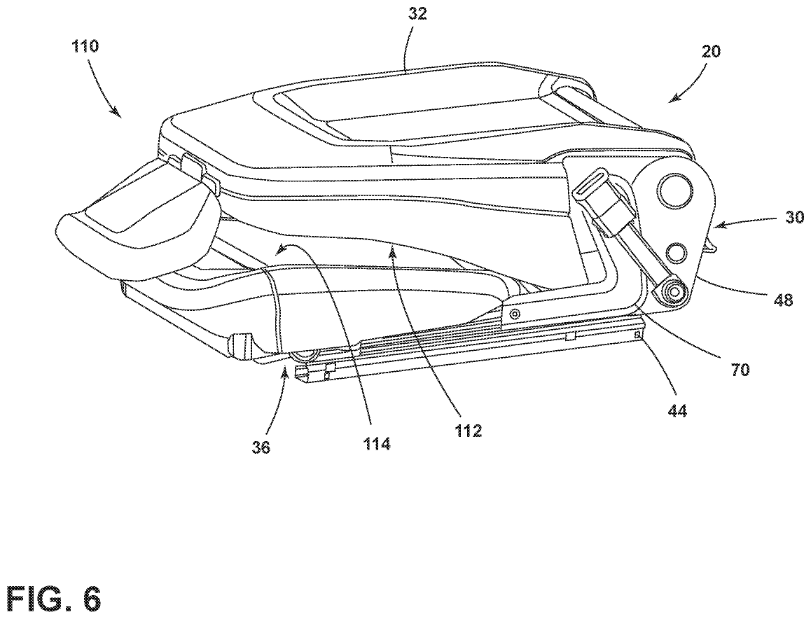

With reference to FIG. 6, the first contour 112 may be complementary to the second contour 114 when the seat back 32 is in the folded position 110.

Advantages to the disclosed seating assembly 20 include a stowed configuration that is lower. Additionally, the seat portion 36 of the seating assembly 20 remains generally parallel to the floor 16 such that more space can be utilized as the seat back 32 pivots between the upright position 100 and the folded position 110.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle seating assembly comprising:
a seat base;
a seat back pivotably coupled with the seat base;
a seat portion pivotably coupled with the seat back, the seat portion pivotably coupled with the seat base, wherein the seat portion includes an L-shaped lateral member having a first arm and a second arm acutely angled from the first arm, the L-shaped lateral member pivotably connected to the seat back at the first arm, the L-shaped lateral member pivotably connected to the seat base at the second arm; and
an articulation mechanism coupled to the seat back to pivot the seat back between an upright position and a folded position, wherein the seat portion translates in response to the seat back pivoting.

2. The vehicle seating assembly of claim 1, wherein the seat portion includes:
a first end coupled with the seat back; and
a second end opposite the first end, the second end coupled with the seat base.

3. The vehicle seating assembly of claim 1, wherein the seat base includes:
a track coupled with a vehicle floor, the track having a back end and a front end opposite the back end;
a support member coupled with the track at the back end, the support member pivotably coupled with the seat back, the support member extending between the support member and the seat back; and
a leg pivotably coupled with the front end of the track, the leg pivotably coupled with the seat portion, the leg extending between the front end of the track and the seat portion.

4. The vehicle seating assembly of claim 3, wherein the seat portion, the track, and the vehicle floor remain substantially parallel as the seat back pivots.

5. The vehicle seating assembly of claim 4, wherein the support member is statically coupled with the track.

6. The vehicle seating assembly of claim 1, wherein the seat portion translates forward in response to the seat back pivoting toward the folded position.

7. The vehicle seating assembly of claim 1, wherein the seat portion translates downward in response to the seat back pivoting toward the folded position.

8. The vehicle seating assembly of claim 1, wherein the seat back has a first contour, and wherein the seat portion has a second contour complementary of the first contour when the seat back is in the folded position.

9. The vehicle seating assembly of claim 1, wherein the seat back pivots relative to the seat portion about a first axis, wherein the seat back pivots relative to the seat base about a second axis, and wherein the first axis rotates about the second axis.

10. A vehicle comprising:
a seating assembly including:
a seat base including:
a track having a back end and a front end;
a leg pivotably coupled with the front end of the track; and
a support member statically coupled with the back end of the track;
a seat back pivotably coupled with the support member;
a seat portion having a first end and a second end, the first end pivotably coupled with the seat back, the second end pivotably coupled with the leg; and
an articulation mechanism coupled to the seat back to pivot the seat back between an upright position and a folded position, wherein the leg rotates about the front end of the track in response to the seat back pivoting, and wherein the seat portion translates between a disposed, forward position and a seating position in response to the seat back pivoting.

11. The vehicle of claim 10, wherein the seat back pivots relative to the first end of the seat portion about a first axis, wherein the seat back pivots relative to the seat base about a second axis, and wherein the first axis rotates about the second axis.

12. The vehicle of claim 11, wherein the seat portion translates forward and downward in response to the seat back pivoting toward the folded position.

13. The vehicle of claim 12, wherein an angle between the track and the seat portion remains constant as the seat portion translates.

14. The vehicle of claim 13, wherein the angle is about zero degrees.

15. The vehicle of claim 10, wherein the articulation mechanism includes a motor.

16. The vehicle of claim 10, wherein the seat portion includes:
a platform assembly;
an L-shaped lateral member coupled with the platform assembly at the second end of the seat portion; and
a seat cross member coupled with L-shaped lateral member between the first end and the second end, the platform assembly coupled with the seat cross member.

17. The vehicle of claim 16, wherein the platform assembly slopes between the second end and the first end.

18. The vehicle of claim 10, wherein the second end of the seat portion orbits the front end of the track.

19. A seating assembly for a vehicle, the seating assembly comprising:
a seat base including:
a pair of tracks having a back end and a front end, the pair of tracks coupled by a track cross member extending therebetween;
a pair of legs pivotably coupled with the front end of the pair of tracks, respectively; and
a pair of support members statically coupled with the back end of the pair of tracks, respectively, the pair of support members coupled by a support cross member extending therebetween;
a seat back pivotably coupled with the pair of support members, wherein the seat back pivots between an upright position and a folded position;
a seat portion including:
a pair of L-shaped lateral members having a first arm and a second arm, the first arm pivotably coupled with the seat back, the second arm pivotably coupled with the leg;
a seat cross member coupled with the pair of L-shaped lateral members at the second arm, the seat cross member extending between the pair of L-shaped lateral members; and
a platform assembly coupled with the second arm of the pair of L-shaped lateral members and the seat cross member, the platform assembly extending therebetween; and
an articulation mechanism coupled to the seat back to pivot the seat back between an upright position and a folded position, wherein the pair of legs rotate about the front end of the pair of tracks in response to the seat back pivoting, and wherein the seat portion translates between a disposed, forward position and a seating position in response to the seat back pivoting.

20. The seating assembly of claim 19, wherein the first arm of the pair of L-shaped lateral members orbits a first axis in response to the seat back pivoting, the first axis extending through the first arm and the seat back, wherein the second arm of the pair of L-shaped lateral members orbits a third axis in response to the seat back pivoting, the third axis extending through the front end of the pair of tracks and the pair of legs, and wherein the seat portion remains substantially parallel to the pair of tracks.
